(19) United States
(12) Patent Application Publication
(10) Pub. No.: US 2014/0028050 A1
(43) Pub. Date: Jan. 30, 2014

(54) TRAILER SKIRT

(71) Applicant: Raul RODRIGUEZ, Wyoming, MI (US)

(72) Inventor: Raul RODRIGUEZ, Wyoming, MI (US)

(21) Appl. No.: 13/560,970

(22) Filed: Jul. 27, 2012

(51) Int. Cl. B62D 35/00

(52) U.S. Cl. CPC B62D 35/001
USPC 296/180.4

(57) ABSTRACT

The present invention pertains to a trailer skirt panel comprising: (a) a sheet having a top section and a bottom section; (b) at least one L-bracket attached to the top section of the sheet; (c) at least one rib extending downwardly from the top section and the L-bracket to provide rigidity to the panel during use; and wherein the sheet, the L-bracket, and the rib comprise a polymer material and are integrally formed together in a unitary construction. The polymer material of the trailer skirt panel can comprise thermoplastic polyolefin. The bottom section of the sheet can include an angled edge to provide rigidity to the panel during use. Furthermore, two or more of the trailer skirt panels can be positioned next to each other to form a trailer skirt assembly for attachment to the bottom of a trailer.

### BACKGROUND OF THE INVENTION

1. Field of the Invention

The present invention pertains to trailer skirts. More particularly, the present invention pertains to trailer skirts for use with tractor-trailer rigs to reduce drag and increase fuel economy. Even more particularly, the present invention pertains to trailer skirts which are designed to reduce installation costs and increase the useable life of the trailer skirt, thereby increasing the cost savings to the user.

2. Description of the Prior Art

Modern cars are quite aerodynamically efficient, but limited progress has been made with heavy-duty vehicles, trucks, and the like. This is unfortunate because these vehicles represent a significant amount of the highway traffic, and the fuel consumption by these vehicles is high. Therefore any improvement in its aerodynamics performance is of great significance to improving fuel economy for transportation tractor-trailer rigs of the transportation industry.

When it comes to reducing operational costs, acceleration and speed are, in general, of little interest in trucking. Existing performance in these fields is considered adequate. However, operational fuel costs can be staggering, and therefore fuel consumption is a major concern. It has recently been suggested that higher fuel prices, coupled with intense competition, may have the effect of closing down certain carriers. It has also been seen how dramatic spikes in fuel costs can cripple the trucking industry and have a direct impact of the cost of goods that are transported by tractor-trailers.

As the trailer of a large tractor-trailer rig is pulled forward by the tractor, a great deal of turbulence is created along the side and underneath the trailer as the vehicle disturbs the air. This turbulence results in increased resistance to forward movement of the tractor-trailer rigs, and thus to lower fuel efficiency.

Moving freight by highway trucks has been increasing in volume for several years, and it appears that it will continue to increase in the future. This method of freight handling has proved to be more efficient and quicker than any other means in a large majority of situations. Nevertheless, this method has need of further improvement. A large problem is the energy needed to overcome wind resistance. It has been recognized that, by streamlining, vehicles can accomplish great savings in fuel expenses. Eddy currents are produced underneath the truck and its trailers, which add to the wind resistance. There is thus a great need to provide a maximum streamlining effect in order to reduce fuel consumption and operating costs.

Trucks, and particularly tractor-trailer rigs having multiple rear wheels, present a high resistance to air flow with the rear wheels, suspension, and other mechanical components at the rear of the vehicle interfering with the smooth flow of air around and under the vehicle. This interference creates turbulence and a high aerodynamic drag, which results in high fuel use and a high cost of operation. Furthermore, the turbulent flow can affect the trailer's ability to track behind the trailer. This reduced driving stability is most prevalent in high crosswind conditions or when the trailer is empty. Furthermore, the turbulent flow, caused by yaw angle air traveling across the trailer bottom and releasing from the downwind side, creates a hazard for the drivers of other vehicles when it is raining or snowing, or the roadway is wet. In these situations, the rain or snow and any water splashed up from the roadway by the tires swirls around the tires and is thrown outwardly by the tires themselves and by the turbulent air flow. When this splashing and spraying water strikes the windshields of other vehicles, it lowers visibility for those motorists, and can cause them to lose control of their vehicles. Further, the spray raised by the rear tires reduces the truck driver's vision of the rear of the truck, making it more difficult for the truck driver to handle the vehicle when it's moving in traffic. It is therefore advisable to improve the visibility of the driver.

It is well known that the fuel efficiency of any motor-driven vehicle is directly related to the aerodynamic structure of the vehicle and the amount of atmospheric turbulence caused by the movement of the vehicle. The greater the air turbulence created by the vehicle the greater the resistance, and the more fuel required to move the vehicle. In today's economy, fuel efficiency is of major concern and is particularly relevant when considered in terms of large tractor trailers used for transporting goods wherein the cost of fuel consumed moving the goods directly affects the market price of the goods. It is well known that improving the aerodynamics of a vehicle improves many aspects of its performance, particularly acceleration, top speed, fuel economy tracking stability and tire wear, driver comfort and ease of driving in cross winds.

Although fuel efficiency has become a primary concern in the recent decade because of fuel cost, a second major consideration is that of increasing the safety of operation of tractor-trailer rigs, particularly from the point of view of safety of other motorists sharing the road with such rigs. A major disadvantage of tractor trailers on the highway is that, unaltered, the turbulent air flow beneath and behind a tractor trailer is generally in a direction transverse to that of the movement of the tractor trailer. This means that in wet or snowy conditions, mist and/or snow is thrown laterally of the trailer causing a vision and turbulence problem for any motorist passing or being passed by the tractor-trailer rig.

Many modifications and accessories have been developed to improve the streamline of the airflow around a combined tractor-trailer truck. It is known that the amount of fuel required to haul a trailer over long distances can be reduced by equipping the trailer with a suitable aerodynamic skirt. One type of skirt is mounted beneath each of the trailer's lower, outer longitudinal edges to extend between the trailer wheel assembly and the wheels of the tractor unit used to haul the trailer. Improved fuel economy is achieved while the trailer is hauled at highway speeds over long distances with skirts or side skirts mounted.

There exists in the prior art a number of different trailer skirt designs. For example, U.S. Pat. No. 7,578,541 to Layfield et al. discloses a multi-paneled skirt which includes the skirt panels and bracket pieces for connecting the panels to the underside of the trailer.

In addition, U.S. Pat. No. 7,748,772 to Boivin et al. discloses a skirt panel which is secured to the underside of the trailer using a plurality of “L” brackets. To provide additional rigidity, yet also provide resilient flexibility when an obstacle is encountered, a number of flexible struts are provided. The flexible struts extend at approximately a 45° angle between the skirt panel and the beams on the underside of the trailer. The flexible struts act as a spring to hold the skirt panel in position during high-speed travel, yet also allow the skirt to flex inwardly toward the trailer when an obstacle is encountered, such as a snowbank or an elevated curb during a tight corner.

Since the justification for installing skirts on a trailer is to reduce costs, the duration of the usable life of the skirts and the installation costs are also significant considerations that impact the overall return-on-investment and the total attainable savings for any given set of trailer skirts that are purchased.

Many of the skirts today are formed from fiberglass, which do not hold up to the elements for very long. In addition, fiberglass is a relatively brittle material that can easily crack. As soon as the skirt is rendered no longer usable, its life is over and it cannot provide any additional fuel savings.

In addition, the ease of installation and the resulting overall time required to install the skirts has a direct impact on the initial expense that is in addition to purchasing the skirts. The amount of expense initially incurred directly affects the user's return-on-investment.

Thus, it is seen that the total initial expenses occurred and premature failure of the product can detrimentally cooperate to reduce the “cost savings” portion of a skirt's life.

The present invention, as is detailed hereinbelow, seeks to resolve these issues by providing a trailer skirt which has a unitary construction to reduce the installation time and resulting labor costs), and is also formed from a superior material which provides added durability and longevity to the life of the skirt. In combination, these advantages provide a trailer skirt which increases the overall cost savings over other trailer skirts in the prior art.

### SUMMARY OF THE INVENTION

In a first embodiment hereof, the present invention provides a trailer skirt panel comprising: (a) a sheet having a top section and a bottom section; (b) at least one L-bracket attached to the top section of the sheet; (c) at least one rib extending downwardly from the top section and the L-bracket to provide rigidity to the panel during use; and (d) wherein the sheet, the L-bracket, and the rib comprise a polymer material and are integrally formed together in a unitary construction.

Optionally, the polymer comprises thermoplastic polyolefin.

Optionally, the bottom section of the sheet includes an angled edge to provide rigidity to the panel during use.

Optionally, the rib protrudes from the sheet and the L-bracket to resist bending between the sheet and the L-bracket.

Another object of the invention is to provide a trailer skirt assembly for attachment to the bottom of a trailer comprising two or more of the trailer skirt panels described above.

Optionally, the trailer skirt assembly can include a pair of adjacent skirt panels that form an overlapping portion to facilitate attachment to each other. The overlapping portion has a plurality of horizontal slots on one of the skirt panels, and the overlapping portion has a plurality of vertical slots on the other panel. The horizontal and vertical slots are aligned to allow a fastener to pass therethrough, wherein each aligned pair of horizontal and vertical slots allow the pair of adjacent skirt panels to move horizontally and vertically with respect to each other.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a perspective view of one embodiment of the trailer skirt;

FIG. 2 is a perspective view of a second embodiment of the trailer skirt;

FIG. 3 is a perspective view of a third embodiment of the trailer skirt;

FIG. 4 is a perspective view showing a trailer skirt being connected to a second adjacent trailer skirt, as well as the clamps attaching the trailer skirts to the I-beams on the underside of a trailer;

FIG. 5 is an enlarged top perspective view showing the clamps and the L-bracket in greater detail;

FIG. 6 is an enlarged bottom perspective view showing a clamp and L-bracket in even greater detail; and

FIG. 7 is a perspective view showing four separate trailer skirts being attached in side-by-side relation to form a trailer skirt assembly.

### DETAILED DESCRIPTION OF THE PREFERRED EMBODIMENT

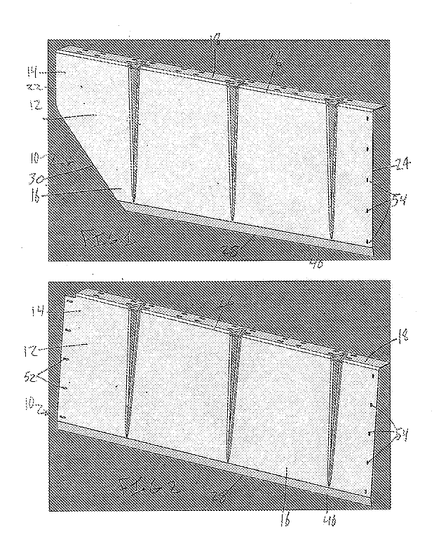

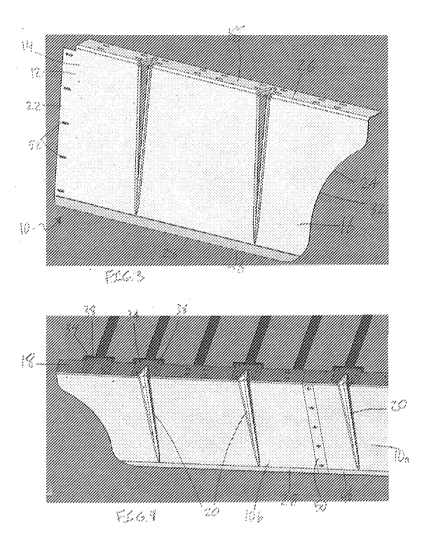

In accordance with the present invention and as shown generally in FIGS. 1-3, there is provided a trailer skirt panel 10 comprising: (a) a sheet 12 having a top section 14 and a bottom section 16; (b) at least one L-bracket 18 attached to the top section 14 of the sheet 12; (c) at least one rib 20 extending downwardly from the top section 14 and the L-bracket 18 to provide rigidity to the panel 10 during use; and (d) wherein the sheet 12, the L-backet 18, and the rib 20 comprise a polymer material and are integrally formed together in a unitary construction.

The sheet 12 is generally planar and flat, although it may have a minimal bend, or curve to it, so as to allow a leading edge 22 to be positioned closer toward the center of the trailer (not shown) to direct turbulent air laterally outwardly and away from underneath the trailer. Opposite the leading edge 22 is a trailing edge 24, in addition to a top edge 26 and a bottom edge 28. The edges 22,24,26,28 are each preferably straight and linear. The panel 10 also includes a top section 14 and a bottom section 16. Although it is dependent upon the type of material used, the panel 10 preferably has a thickness in the range of about 0.15″-0.35″. When the panel 10 is formed from a polymeric material, the thickness is preferably about 0.2″-0.25″. In addition, the sheet 12 is preferably about 28″-36″ in height (from top edge 26 to bottom edge 28). Even more preferably, the height of the sheet 12 is about 32″.

The leading edge 22 can include a slanted edge 30 forming an angled cut-out in the bottom section 16. In addition, the trailing edge 24 may include a semi-circular cut-out 32 around the trailer's wheels (not shown) to allow the trailer skirt panel 10 to be contoured around the wheels.

At least one “L-shaped” L-bracket 18, or flange, is attached to the top section 14 of the sheet 12 along the top edge 26. The L-bracket 18 is a planar extension that is preferably flat and of the same or similar thickness as the sheet 12. The skirt panel 10 can include a plurality of L-brackets 18 positioned along the length of the top edge 26. Preferably, a single L-bracket 18 is provided which extends off the entire length of the top edge 26. The L-bracket 18 is provided to facilitate attachment to the underside of a trailer. The L-bracket 18 also provides some amount of structural rigidity to the top section 14 of the skirt panel. Preferably, the L-bracket 18 is at approximately a 90° angle with respect to the sheet 12.

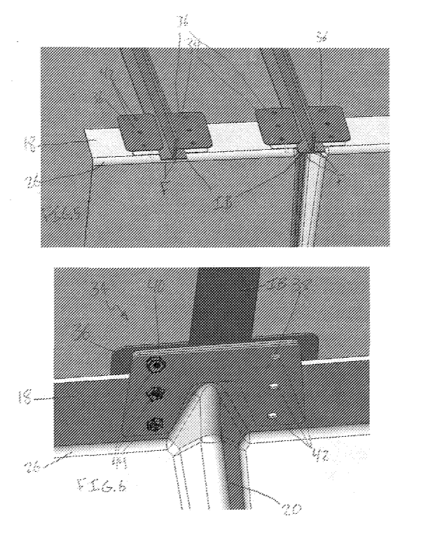

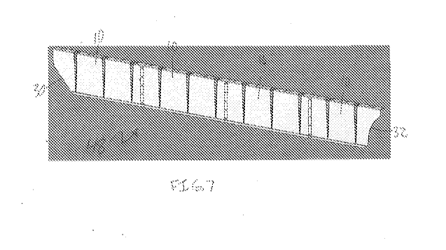

Means for connecting the L-bracket 18 to the underside of the trailer are well-known in the art. It is known to be advantageous for a trailer skirt to be securely attached to the underside of the trailer without comprising the integrity of the trailer, such as by drilling holes through any frame members on the trailer. As is well-known in the art and shown in FIGS. 4-6, clamps 34 are preferably used to attach the L-bracket 18 to the trailer. Trailers typically have a number of I-beams IB running from side-to-side down the length of the trailer. These I-beams IB are typically 12″ apart. The clamps 34 used often include an upper plate 36, a lower plate 38, and sometimes shims 40 as well. The upper plate 36 is placed above the lower flanges F on the I-beam IB, and the lower plate 38 is positioned below the L-bracket 18. When provided, the shims 40 may be used to adjust for the thickness of the L-bracket 18. The upper plate 36, lower plate 38, and L-bracket 18 include aligned holes 42 and fasteners 44, such as bolts, that pass through the aligned holes 42 to secure the upper and lower plates 38 around the lower flange F of the I-beam IB and the L-bracket 18. In this manner, clamps 34 may be used to secure the L-bracket 18 to any I-beam IB, if not all of the I-beams IB that contact the L-bracket 18. Preferably, ribs 20 (described in detail below) are positioned at specified intervals along the sheet 12, for example every 24″ or 36″. The clamps 34 are preferably located at the same locations as the ribs 20, although additional clamps 34 may be provided as well.

Turning back to the skirt panel 10, the sheet 12 includes at least one rib 20 extending downwardly from the top section 14 and the L-bracket 18 toward the bottom section 16 to provide rigidity to the panel 10 during use. During high-speed travel, the sheet 12 experiences substantial flexing and vibration due to turbulence and wind sheer forces that tend to cause the sheet 12 to shake or wave. The rib 20 is provided to add structural stability to help keep the sheet 12 from moving with respect to the L-bracket 18. The rib 20 is formed integrally with the sheet 12 and L-bracket 18 as a unitary piece, or construction.

The rib 20 extends along the sheet 12 and up into the L-bracket 18, and protrudes outwardly from the sheet 12 and the L-bracket 18 to resist bending therebetween. As shown in the drawings, the rib 20 is preferably thickest near the top edge 26 at the junction between the top section 14 and L-bracket 18. The rib 20 can narrow and decrease in thickness (or the amount of protrusion) as it extends downwardly toward the bottom section 16 of the sheet 12. Although the drawings show a detent at the location of rib 20s on the opposite side of the sheet 12, the sheet 12 can also optionally have a flat surface at that position such that the location of the rib 20 is not noticeable from that side. Providing a flat surface rather than a detent may be beneficial in reducing drag, although some manufacturing processes may not allow for a flat surface at that location.

The sheet 12, L-bracket 18, and the rib 20 are integral together and form a unitary construction, or piece, with each other to form the trailer skirt panel 10. Preferably the skirt panel 10 is formed from a polymeric or composite material. Even more preferably, the skirt panel 10 is formed from thermoplastic polyolefin (TPO).

The skirt panel 10 can be formed using any suitable methods, including plastic injection molding, extrusion, vacuum-forming, or combinations thereof. Preferably, the skirt panel 10 is formed by first extruding the sheet 12 to a specified thickness, and then vacuum-forming the additional elements.

Optionally, the bottom section 16 of the sheet 12 can include an angled edge 46 to provide rigidity to the panel during use. The angled edge 46 can provide substantial strength against the wind forces which may cause the sheet 12 to flex and twist. In order to provide a skirt panel 10 which accomplishes its objective of reducing drag and increasing fuel efficiency, the sheet 12 should not flex or twist during use, which can potentially increase drag. The angled edge 46 can be angled at any suitable position with respect to the sheet 12. For instance, the angled edge 46 can be bent between approximately 20° and 90°.

Optionally, in addition to (or instead of) the ribs 20, the panels 10 may include ribs 20 at other orientations. For instance, horizontal rib (not shown) may be optionally provided to add strength as well.

As show in FIGS. 4 and 7, another object of the invention is to provide a trailer skirt assembly 48 for attachment to the bottom of a trailer comprising two or more of the trailer skirt panels 10 described 20 above. Although a single skirt panel 10 may extend the entire necessary length of the trailer, a plurality of skirt panels 10 can be positioned in side-by-side relation with each other to complete the full length necessary.

As seen in FIG. 4, the adjacent skirt panels 10 can be secured to each other by abutting, or overlapping, the trailing edge 24 of the leading panel 10a over the leading edge 22 of the next successive panel 10b. This pair of adjacent skirt panels 10a,10b forms an overlapping portion 50 to facilitate attachment to each other. The overlapping portion 50 has a plurality of horizontal slots 52 on either of the skirt panels, and the overlapping portion 50 has a plurality of vertical slots 54 on the other panel. The horizontal and vertical slots 52,54 are aligned, or overlapped, to allow a fastener (not shown) to pass therethrough. By providing both horizontal and vertical slots 52,54 at the same connection point, the pair of adjacent skirt panels can move both horizontally and vertically with respect to each other. This adjustability can be beneficial in allowing for inconsistencies during installation. It can also be beneficial to allow for expansion and contraction due to temperature changes or if the frame of the trailer flexes when it is loaded with cargo.

From the preceding it is seen that the trailer skirt panel and assembly accomplish the goal of providing a product which is easier to assemble and also has increased durability and longevity. Trailer skirt panels in the prior art have multiple struts and/or brackets which are necessary to attach the panel to the underside of the trailer. By providing a skirt panel which has the L-bracket, the rib(s), and the panel all integrally formed together, installation is simplified because the clamps simply need to be used to attach the L-bracket to the I-beams. Trailer skirts in the prior art require the brackets to first be attached to the panel before (or after) the brackets are secured to the I-beams. The present invention provides a simplification of the installation process, which in turn leads to lower installation costs and allows a quicker return-on-investment.

Likewise, the superior material of the present invention provides a superior product which has greater durability over the prior art, and therefore provides a longer “cost-savings” life of the product.

As is apparent from the preceding, the present invention provides a trailer skirt which is easy and relatively cheap to install, and which has a long product life, thereby providing a trailer skirt which will provide greater fuel efficiency cost savings over the life of the product.

What is claimed is:

1. A trailer skirt panel comprising:
(a) a sheet having a top section and a bottom section;
(b) at least one L-bracket attached to the top section of the sheet;
(c) at least one rib extending downwardly from the top section and the L-bracket to provide rigidity to the panel during use; and
(d) wherein the sheet, the L-bracket, and the rib comprise a polymer material and are integrally formed together in a unitary construction.

2. The trailer skirt panel of claim 1 wherein the polymer comprises thermoplastic polyolefin.

3. The trailer skirt panel of claim 2 wherein the bottom section of the sheet includes an angled edge to provide rigidity to the panel during use.

4. A trailer skirt assembly for attachment to the bottom of a trailer comprising two or more of the trailer skirt panels of claim 3.

5. The trailer skirt assembly of claim 4 wherein the rib of at least one of the trailer skirt panels protrudes from the sheet and the L-bracket to resist bending between the sheet and the L-bracket.

6. The trailer skirt assembly of claim 5 including a pair of adjacent skirt panels that form an overlapping portion to facilitate attachment to each other, the overlapping portion having a plurality of horizontal slots on one of the skirt panels, and the overlapping portion having a plurality of vertical slots on the other panel, the horizontal and vertical slots being aligned to allow a fastener to pass therethrough, wherein each aligned pair of horizontal and vertical slots allow the pair of adjacent skirt panels to move horizontally and vertically with respect to each other.

7. The trailer skirt assembly of claim 3 wherein the rib of at least one of the trailer skirt panels protrudes from the sheet and the L-bracket to resist bending between the sheet and the L-bracket.

8. The trailer skirt assembly of claim 4 including a pair of adjacent skirt panels that form an overlapping portion to facilitate attachment to each other, the overlapping portion having a plurality of horizontal slots on one of the skirt panels, and the overlapping portion having a plurality of vertical slots on the other panel, the horizontal and vertical slots being aligned to allow a fastener to pass therethrough, wherein each aligned pair of horizontal and vertical slots allow the pair of adjacent skirt panels to move horizontally and vertically with respect to each other.

9. The trailer skirt panel of claim 2 wherein the bottom section of the sheet includes an angled edge to provide rigidity to the panel during use.

10. A trailer skirt assembly for attachment to the bottom of a trailer comprising two or more of the trailer skirt panels of claim 9.

11. The trailer skirt assembly of claim 10 wherein the rib of at least one of the trailer skirt panels protrudes from the sheet and the L-bracket to resist bending between the sheet and the L-bracket.

12. The trailer skirt panel of claim 9 wherein the rib protrudes from the sheet and the L-bracket to resist bending between the sheet and the L-bracket.

13. The trailer skirt assembly of claim 10 including a pair of adjacent skirt panels that form an overlapping portion to facilitate attachment to each other, the overlapping portion having a plurality of horizontal slots on one of the skirt panels, and the overlapping portion having a plurality of vertical slots on the other panel, the horizontal and vertical slots being aligned to allow a fastener to pass therethrough, wherein each aligned pair of horizontal and vertical slots allow the pair of adjacent skirt panels to move horizontally and vertically with respect to each other.

14. A trailer skirt assembly for attachment to the bottom of a trailer comprising two or more of the trailer skirt panels of claim 1.

15. The trailer skirt assembly of claim 14 wherein the rib of at least one of the trailer skirt panels protrudes from the sheet and the L-bracket to resist bending between the sheet and the L-bracket.

16. The trailer skirt assembly of claim 14 including a pair of adjacent skirt panels that form an overlapping portion to facilitate attachment to each other, the overlapping portion having a plurality of horizontal slots on one of the skirt panels, and the overlapping portion having a plurality of vertical slots on the other panel, the horizontal and vertical slots being aligned to allow a fastener to pass therethrough, wherein each aligned pair of horizontal and vertical slots allow the pair of adjacent skirt panels to move horizontally and vertically with respect to each other.

17. The trailer skirt assembly of claim 15 including a pair of adjacent skirt panels that form an overlapping portion to facilitate attachment to each other, the overlapping portion having a plurality of horizontal slots on one of the skirt panels, and the overlapping portion having a plurality of vertical slots on the other panel, the horizontal and vertical slots being aligned to allow a fastener to pass therethrough, wherein each aligned pair of horizontal and vertical slots allow the pair of adjacent skirt panels to move horizontally and vertically with respect to each other.

18. The trailer skirt panel of claim 1 wherein the rib protrudes from the sheet and the L-bracket to resist bending between the sheet and the L-bracket.

19. A trailer skirt panel comprising:
(a) a sheet having a top section and a bottom section;
(b) at least one rib extending downwardly from the top section to provide rigidity to the panel during use; and
(c) wherein the sheet and the rib comprise a polymer material and are integrally formed together in a unitary construction.

20. The trailer skirt panel of claim 19 wherein the polymer comprises thermoplastic polyolefin, and the bottom section of the sheet includes an angled edge to provide rigidity to the panel during use.
